(19) United States
(12) Patent Application Publication
(10) Pub. No.: US 2009/0307963 A1
(43) Pub. Date: Dec. 17, 2009

(54) Exterior rodent bait station and lid-securing tool

(76) Inventor: Ben Abbas, Deltona, FL (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/457,454

(22) Filed: Jun. 11, 2009

Related U.S. Application Data
(60) Provisional application No. 61/129,231, filed on Jun. 12, 2008.

(51) Int. Cl. A01M 25/00

(52) U.S. Cl. 43/131

(57) ABSTRACT

The exterior rodent bait station with lid-securing tool has a housing, a pivotally connected lid securable to the housing, and a hollow base removably attachable to the housing. The housing includes holes for entry of rodents attracted to poison bait disposed in the housing interior, the poison bait being secured within the unit by a pivotal bait member. A concrete paving block within the hollow base secures the bait station at its placement location. The bait station lid has a raised section for attachment of a numbered stencil to show placement order of multiple stations. Drainage holes are disposed in the bottom of the housing and sidewalls of the base. A hex lid fastener may be provided along with a push-pull gear-style driving tool to facilitate ease of fastening and unfastening the bait station lid.

### CROSS-REFERENCE TO RELATED APPLICATION

This application claims the benefit of U.S. Provisional Patent Application Ser. No. 61/129,231, filed Jun. 12, 2008.

### BACKGROUND OF THE INVENTION

1. Field of the Invention

The present invention relates generally to pest control systems, and more particularly to an exterior rodent bait station and a lid-securing tool therefor.

2. Description of the Related Art

Bait stations in the form of enclosed- units containing poisoned bait are commonly used for killing rats and mice. The rat or mouse enters the bait station, eats the bait and dies. Such bait stations are preferable to traps that retain the rodent, since the bait station can be used to kill several rodents without requiring constant monitoring.

A preferred type of bait station is designed so that a child cannot open the unit, and cannot gain access to the bait by reaching into the unit.

An exterior rodent bait station requires a technician to secure a cement block to the base of the unit in order to ensure it stays in place and cannot be displaced by people, animals or even weather conditions.

Currently the bait stations available require a technician to drill a hole in the concrete block and with the addition of liquid nails secure the bait station to the block, which is not only a time consuming process, but messy and requires additional materials to complete each station, and if you take into consideration that the average job requires anything from 1 to 20 bait stations to be placed out on a new account, this process can substantially increase the cost of the job. What is needed is a modified version of this product that eliminates the mess, time and cost taken to get the job done.

Current manufacturers do not make provision for identification indicia on top of the bait stations, where you can stencil the numbers of each station to show numerical order of placement. Inspectors like to see this for ease of inspection, as they can go straight to a station off the site plan in the pest control book at random to inspect it, which can be of major benefit to the customer, while showing the professionalism of the pest control company doing the service. It should be understood that some inspectors have a mandatory requirement that the bait stations be numbered.

Thus, an exterior rodent bait station and lid-securing tool solving the aforementioned problems is desired.

### SUMMARY OF THE INVENTION

The exterior rodent bait station has a housing, a pivotally connected lid securable to the housing, and a hollow base removably attachable to the housing. The housing includes holes for entry of rodents attracted to poison bait disposed in the housing interior, the poison bait being secured within the unit by a pivotal elongate member. A concrete paving block within the hollow base secures the bait station at its placement location. The bait station lid has a raised section for attachment of a numbered stencil to show placement order of multiple stations. Drainage holes are disposed in the bottom of the housing and sidewalls of the base. A hex lid fastener may be provided along with a push-pull ratchet-style driving tool to facilitate ease of fastening and unfastening the bait station lid.

These and other features of the present invention will become readily apparent upon further review of the following specification and drawings.

### BRIEF DESCRIPTION OF THE DRAWINGS

FIG. 1 is a partially exploded, perspective view of the exterior rodent bait station according to the present invention.

FIG. 2 is a front view of the exterior rodent bait station according to the present invention.

FIG. 3 is a side view of the exterior rodent bait station according to the present invention.

FIG. 4 is a top view showing the interior of the exterior rodent bait station according to the present invention.

FIG. 5 is a partial perspective view of the exterior rodent bait station according to the present invention, broken away and partially in section to show the bait block rod placement.

FIG. 6 is a partial, perspective view of a lid securing tool according to the present invention, shown attaching the lid to the exterior rodent bait station.

FIG. 7 is a bottom, perspective view of the exterior rodent bait station according to the present invention, showing the bottom of the base.

FIG. 8 is a perspective view of an alternative embodiment of an exterior rodent bait station according to the present invention, showing placement of additional drainage holes and an alternative bait block rod.

Similar reference characters denote corresponding features consistently throughout the attached drawings.

### DETAILED DESCRIPTION OF THE PREFERRED EMBODIMENTS

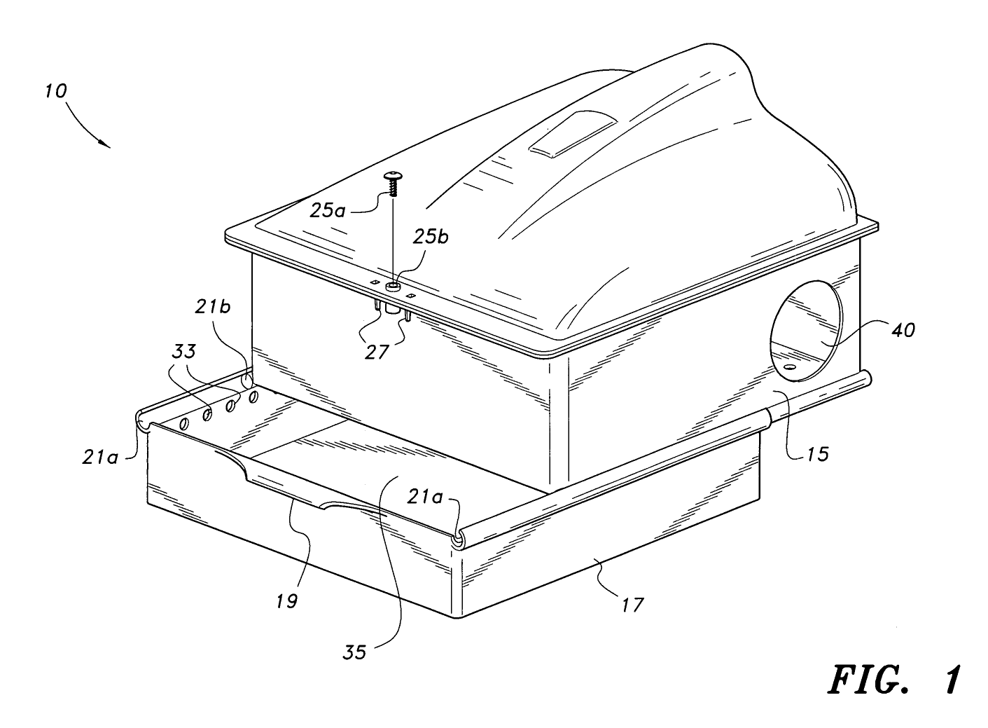

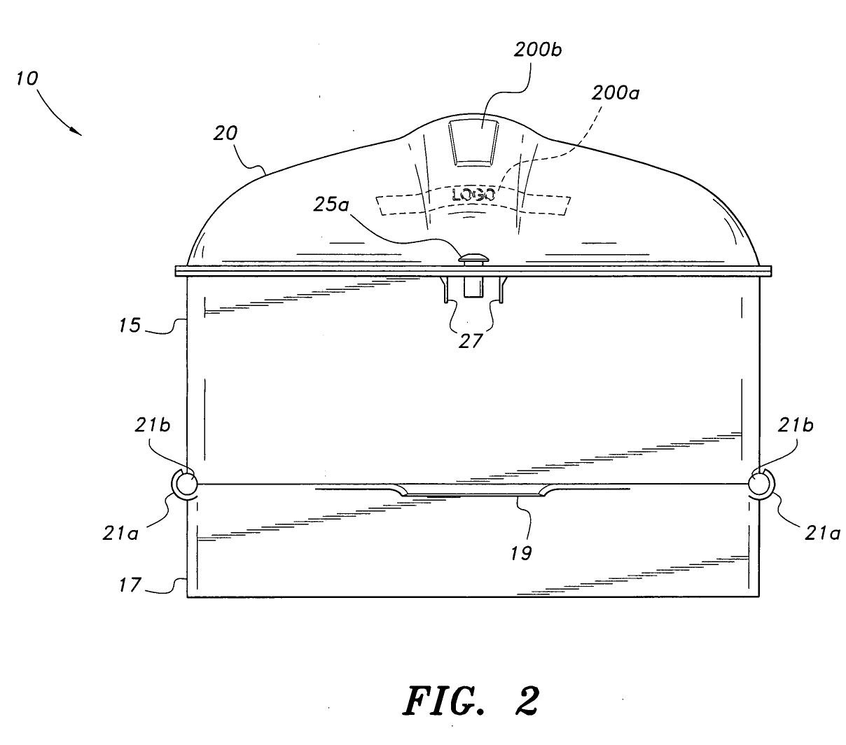

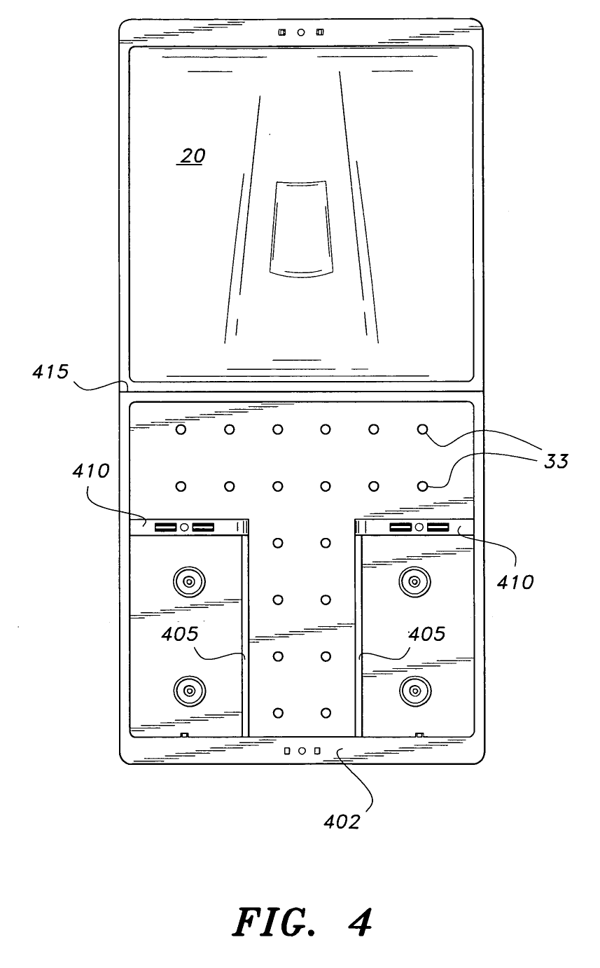

As shown in FIGS. 1-4, the present invention relates to an exterior bait station 10 that comprises a housing 15, a pivotally connected lid 20 securable to the housing 15, and a hollow base 17 removably attachable to the housing 15. As shown in FIGS. 1-2, the removable attachment of housing 15 to hollow base 17 is facilitated by two sliders 21b, which are disposed along opposing sides of the housing 15. The sliders 21b engage housing receiver tracks or troughs 21a, the housing receiver troughs being disposed on opposing sides of the base 17. The base 17 has a handle 19 that a user can grab while attaching and detaching the housing 15.

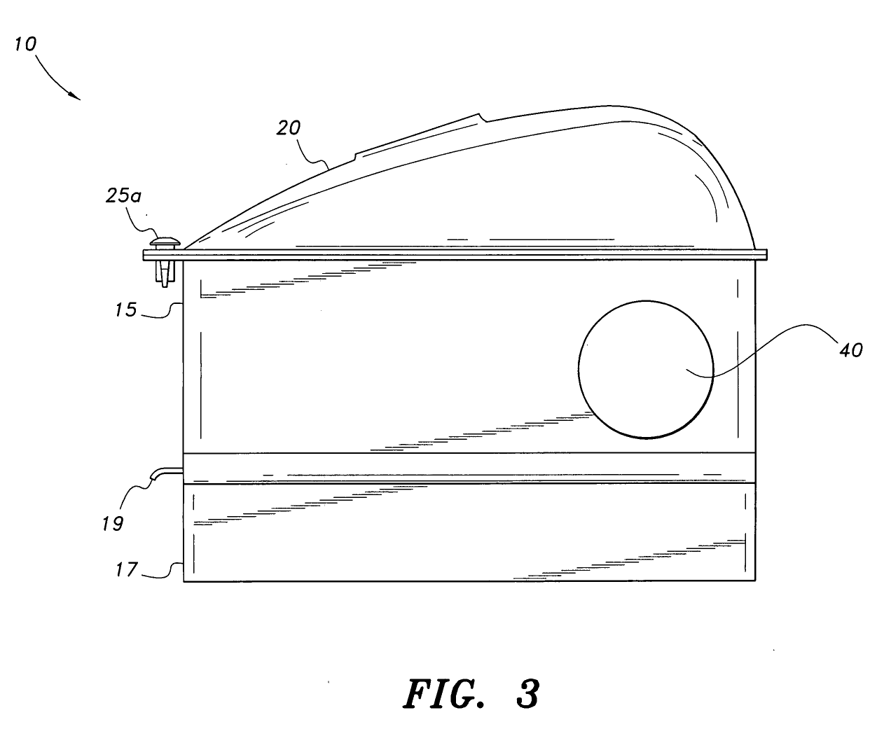

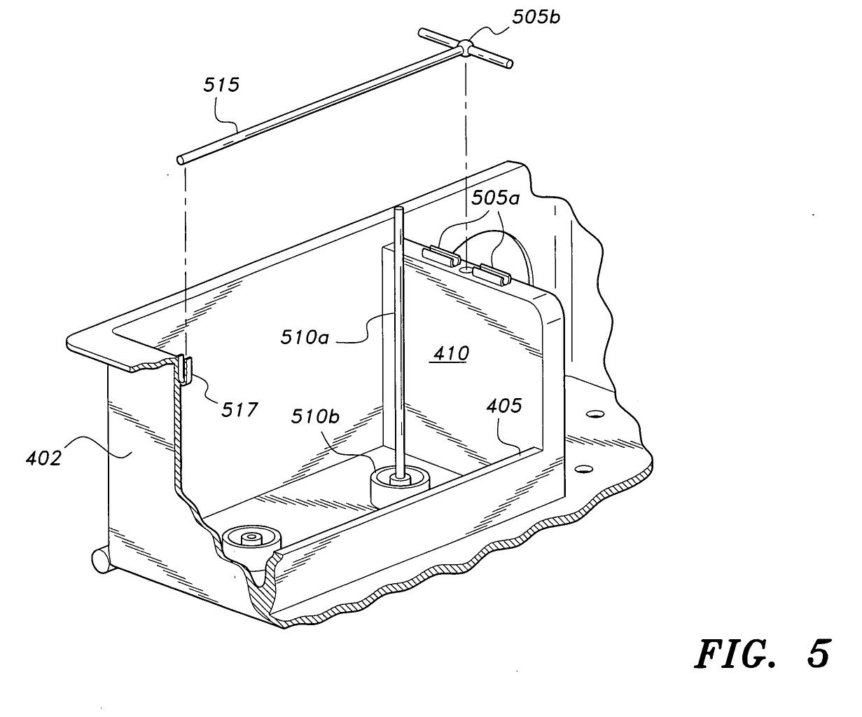

As shown in FIGS. 3, 4 and 5, the housing 15 includes holes 40 for entry of rodents attracted to poison bait disposed in the housing interior, the poison bait being securable within the unit by a pivotal bait member 515. Low walls 405 are orthogonally disposed in the interior with respect to high walls 410. A vertically oriented bait member 510a can be disposed within bait member receptacle 510b. A horizontally disposed elongate bait member 515 is pivotally attached to wall 410. The elongate bait members 510a and 515 may be rods, bars, wires, or any other elongated members that can support poisoned bait. The free-end of elongate bait member 515 rests on a U-shaped guide bracket 517, which is disposed in wall 402. End 505b of elongate bait member 515 is T-shaped, having a crossbar extending normal to the length of the member 515 that engages pivot guides 505a to facilitate a user being able to pivot the bait member 515 away from wall 402 for easy access to hang rodent bait thereon. When the bait is attached to the bait member 515, the user merely pivots the bait member 515 back into engagement with U-shaped bracket 517 on wall 402.

A user can place a concrete paving block within cavity 35 of the hollow base 17 to secure the bait station 10 at its designated placement location.

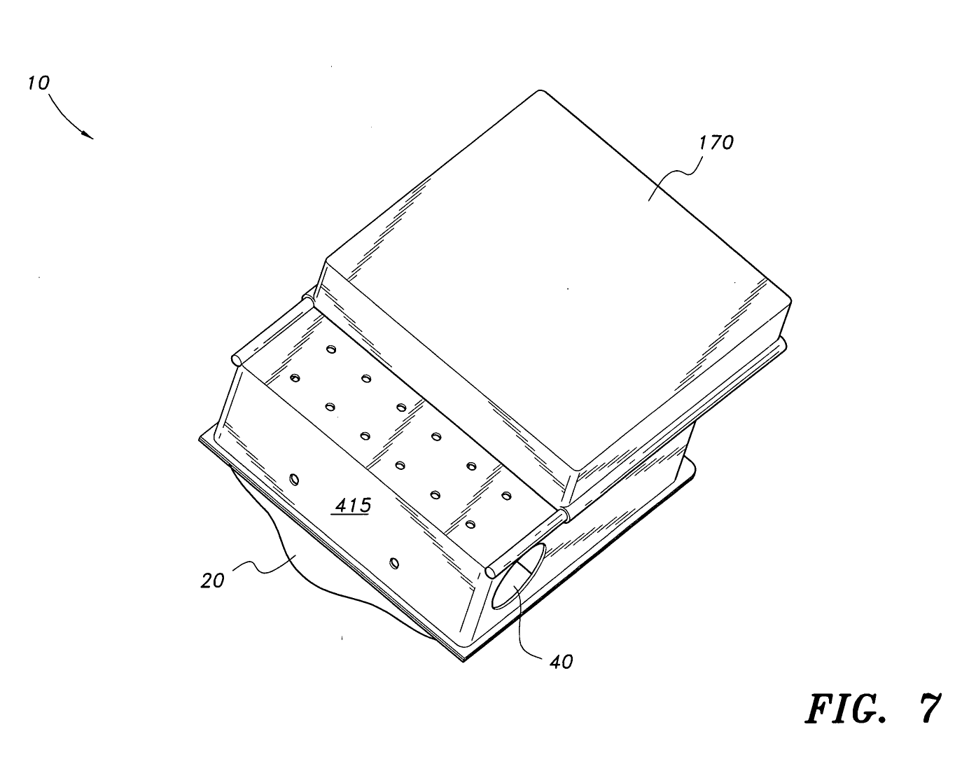

The bait station lid 20 has a raised section 200b for attachment of a numbered stencil to show placement order of multiple stations. Additionally, a strip 200a is provided for display of a custom logo. Drainage holes 33 are disposed in the bottom of housing 15 and sidewalls of base 17. As shown in FIG. 7, underside 170 of the base of unit 10 is preferably flat. The rear wall 415 has a pair of through holes.

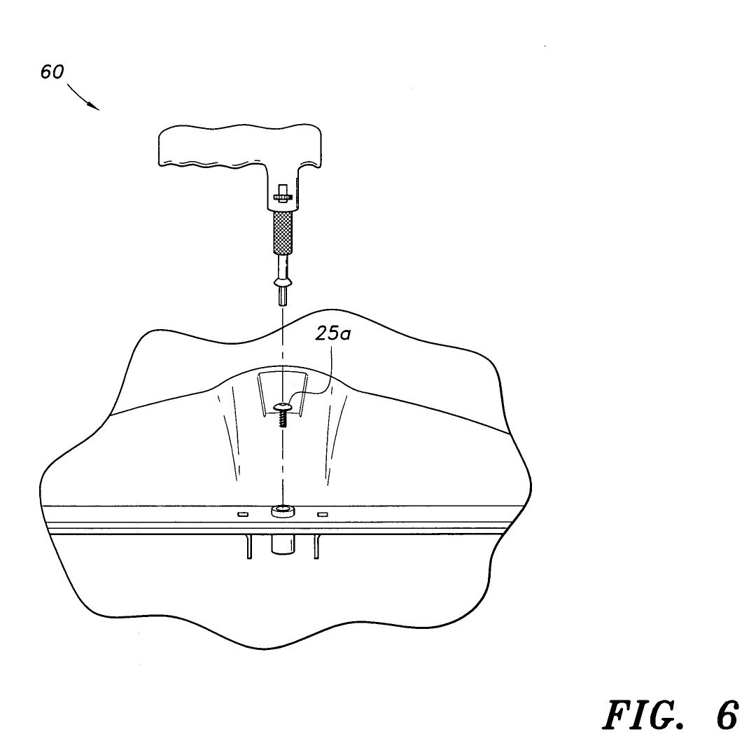

A hex lid fastener 25a may be provided to engage receiving threads 25b to assist lock guides 27 in securing the lid 20 to the housing 15. As shown in FIG. 6, a push-pull gear-style driving tool 60 can be provided to engage the fastener 25a for ease of fastening and unfastening the bait station lid 20.

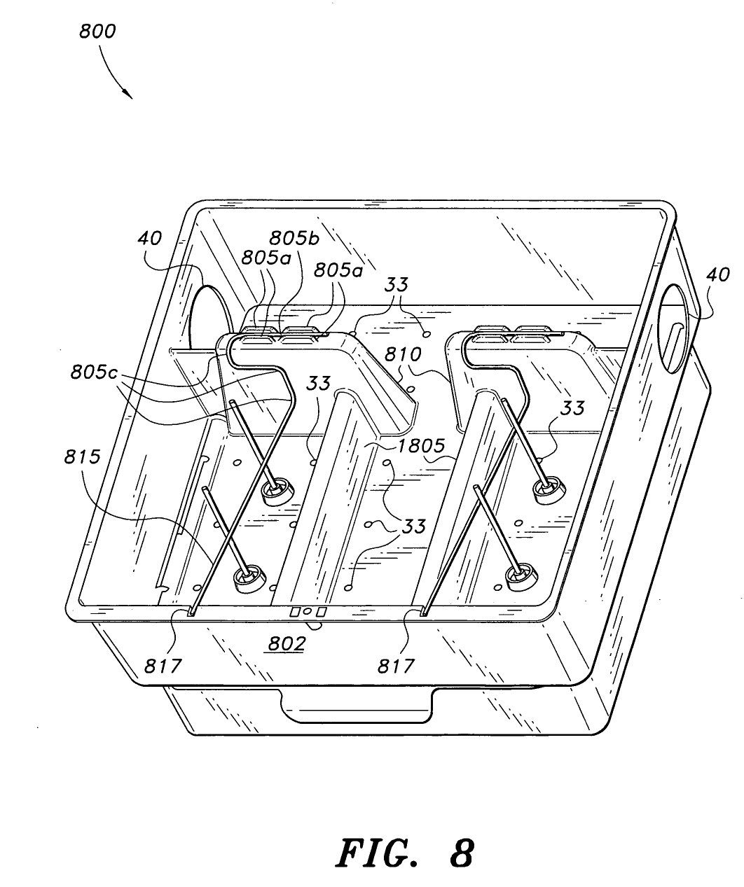

In an alternative embodiment bait station housing 800 shown in FIG. 8, the interior of the rodent bait station is similar to bait station 10, described above, but the horizontally disposed elongate bait member 815 has a different shape from bait member 515, and interior walls 1805 and 810 have a slightly different configuration from corresponding walls 405 and 410, with wall 810 extending laterally beyond its junction with low profile wall 1805.

The elongate bait members 815 may be rods, bars, wires, or any other elongated members that can support poisoned bait. Each elongate bait member 815 has a plurality of contour bends 805c so that the elongate portion of bait member 815 angles upward to engage guide slots 817 disposed in top portion of the housing wall 802.

End 805b of elongate bait member 815 is not co-planar with the elongated portion of member 815, but still includes a bar that extends normal to the plane of the elongated portion of member 815, the bar engaging pivot guides 805a to facilitate a user being able to pivot the bait member 815 about a horizontal axis away from wall 802 for easy access to hang rodent bait thereon. When the bait is attached to the bait member 815, the user merely pivots the bait member 815 back into engagement with notches or guide slots 817 defined in the upper edge of wall 802. Additional drainage holes 33 are disposed within the housing perimeter bounded by walls 810 and 1805.

It is to be understood that the present invention is not limited to the embodiment described above, but encompasses any and all embodiments within the scope of the following claims.

I claim:

1. An exterior rodent bait station, comprising:
a housing defining at least one hole for entry of rodents therein;
a lid removably covering the housing;
a hollow base having a weight therein, the base being removably attached to the housing;
an elongate bait member having a bar extending normal thereto at a first end;
a first interior wall disposed within the housing; and
a second interior wall disposed within the housing, the second interior wall having a pivot attachment receiver, bait member bar engaging the pivot attachment receiver the elongate bait member freely pivoting thereon, a second end of the elongate bait member selectively resting against the first interior wall of the housing.

2. The exterior rodent bait station according to claim 1, further comprising sliders disposed on opposite sides of said housing and receiver troughs disposed on opposite sides of said base, the sliders being slidably disposed in the receiver troughs, whereby said housing is slidably mounted atop said base.

3. The exterior rodent bait station according to claim 1, further comprising a handle disposed on the base for facilitating attachment to and removal from the housing.

4. The exterior rodent bait station according to claim 1, wherein the housing has a bottom having drainage holes defined therein, the base having side portions also having drainage holes defined therein.

5. The exterior rodent bait station according to claim 1, wherein the base has a bottom, the bottom of the base being substantially flat.

6. The exterior rodent bait station according to claim 1, wherein the elongate bait member has an elongate portion non co-planar with the bar and a plurality of contour bends angling upward to the bar.

7. The exterior rodent bait station according to claim 1, further comprising a threaded fastener attached to the lid, the threaded fastener threadably engaging said housing to secure said lid in a position covering said housing.

8. The exterior rodent bait station according to claim 7, further comprising a push-pull ratcheting hand tool facilitating easy threading and unthreading of said threaded lid fastener to and from said housing.

9. The exterior rodent bait station according to claim 1, further comprising a third interior wall joining said first and second interior walls, said third interior wall having a lower profile than said first and said second walls.

10. The exterior rodent bait station according to claim 9, further comprising:
a bait member receptacle disposed inside an interior perimeter space of the housing defined by said first, second, and third interior walls; and
a vertically oriented bait member removably attachable to the bait member receptacle.

11. The exterior rodent bait station according to claim 9, wherein the second interior wall extends within the interior beyond the third interior wall.

12. The exterior rodent bait station according to claim 10, further comprising a plurality of drainage holes disposed in a floor of the interior perimeter space defined by said first, second, and third interior walls of the housing.

13. An exterior rodent bait station kit, comprising:
a housing defining at least one hole for entry of rodents therein;
a lid removably covering the housing;
a fastener removably fastening the lid to the housing;
a fastener tool selectively engaging the fastener to fasten and unfasten the lid;
a hollow base having a weight therein, the base being removably attachable to the housing;
an elongate bait member having a pivot bar at a first end;
a first interior wall disposed within the housing; and
a second interior wall disposed within the housing, the second interior wall having a pivot attachment receiver, the pivot bar rotatably engaging the pivot attachment receiver, the elongate bait member freely pivoting thereon, a second end of the elongate bait member selectively resting against the first interior wall of the housing.
